(19) United States
(12) Patent Application Publication
(10) Pub. No.: US 2006/0217153 A1
(43) Pub. Date: Sep. 28, 2006

(54) Method and system for selecting a mobile communications network

(76) Inventors: Stuart A. Coles, Bishopton (GB); Eric Mora, Clamart (FR)

Correspondence Address: KNOBBE MARTENS OLSON & BEAR LLP, 2040 MAIN STREET, FOURTEENTH FLOOR, IRVINE, CA, 92614, US

(21) Appl. No.: 10/537,006

(22) PCT Filed: Nov. 25, 2003
(86) PCT No.: PCT/GB03/05116

§ 371 Date: Mar. 10, 2006

(30) Foreign Application Priority Data
Nov. 28, 2002 (GB) 0227779.1

(51) Int. Cl. H04M 1/00

(52) U.S. Cl. 455/558; 455/432.1

(57) ABSTRACT

A subscriber identity module for use in mobile communications networks, said subscriber identity module storing a list of preferred mobile communications networks, other than the home mobile network, to be selected for providing services, and said subscriber identity module being adapted to modify said list of preferred networks in response to location information.

This invention relates to mobile telecommunications terminals and methods of communicating via a mobile telecommunications network. More particularly, but not exclusively, the invention relates to a method and system for selecting a mobile telecommunications network.

In a known conventional GSM (Global System for Mobile communications) system, each mobile terminal, such as a mobile telephone handset, is provided with a SIM (Subscriber Identity Module), which is inserted into the mobile station in order to allow the mobile terminal to receive services in a GSM network from a particular service provider or network operator.

A typical SIM includes a microprocessor, memory elements and contacts for forming the data transfer interface between the SIM and the mobile terminal. The SIM card stores information related to a particular subscription with a service provider. For Third Generation (3G) devices, the corresponding module is the Universal Integrated Circuit Card (UICC). In the DECT standards, the corresponding module is known as a DECT authentication module (DAM).

The term subscriber identification module or SIM will be used throughout the specification to include any such module for use in a mobile telecommunications environment.

GSM systems allow for a subscriber to use their mobile terminal when travelling outside the geographical coverage area of the home network; this is referred to as “roaming”. In this way the subscriber may automatically make or receive voice calls, send and receive data, or may access other services by using a visited network The network operators establish roaming based on roaming agreement, defining mobility management, authentication procedures, billing arrangements and other terms.

The SIM stores in a memory file a list of preferred networks, referred to as public land mobile networks (PLMN). Such a list is schematically illustrated in FIG. 3. The list contains entries of such preferred PLMs, wherein the PLMN is listed using a code. The code includes a mobile country code (MCC) followed by the mobile network code (MNC). The list of preferred PLMNs is ordered by priority, i.e. the entries on top of the list have a higher priority compared to the entries further down the list when a network is selected for providing roaming services.

The list of preferred PLMN's is usually preprogrammed by the network operator before sale of the SIM. The list may be updated by the network operator, for example if the operator changes the roaming agreement with other network providers.

This may be done with help of a card reader at a service centre. Alternatively, this can be done remotely “Over the Air” (OTA) using the short message service (SMS) as described in European Patent EP0562820 or using the GSM infrastructure for remotely managing SIM files as described in the GSM specification 03.48.

The preferred networks are usually networks which cooperate with a particular network provider or which offer particular favourable roaming conditions for the network provider or subscriber.

The subscriber may also have an interest in using network providers which cooperate with the home network provider if he is roaming abroad. In this way the user may be offered the same or similar services as from his home service provider.

If a subscriber switches on his mobile terminal when he is abroad, the file of preferred PLMNs is read and the terminal automatically selects a network for the country in which the subscriber is roaming.

As defined in the GSM Technical Specifications, the PLMN file may contain up to fifty entries. However, some mobile terminals consider only the first eight entries of the PLMN list when looking for a suitable preferred network for a roaming subscriber in a particular country.

If no preferred network is found for the particular country, the mobile terminal usually selects the network providing the strongest signals.

One method of enhancing the use of preferred networks known in the art is the use of a file listing forbidden networks. Similar to the PLMN file, this file can be filled by the home network provider with codes of network which must not be selected if the subscriber is roaming abroad.

If all networks for a particular country, except the preferred network, are forbidden, then the mobile communications terminal is forced to select the preferred network. However, it may happen that no service or only limited service is available from the preferred network at certain times or in certain areas. In this case, the user cannot receive any services at all. Therefore the user acceptance for selection of roaming networks using the forbidden network list is low.

A further disadvantage of this system is that the forbidden list is restricted in length, similar to the PLMN list. Therefore, the blocking of networks may only be effective in a few countries, for which the non-preferred networks are listed. For the remaining countries, this blocking of particular networks does not work.

It is therefore an object of the present invention to alleviate the above disadvantage and to provide an improved system for selecting preferred networks.

According to one aspect of the present invention, there is provided a subscriber identity module for use in mobile communications networks, said subscriber identity module storing a list of preferred mobile communications networks, other than the home mobile network, to be selected for providing services, and said subscriber identity module being adapted to modify said list of preferred networks based on location information.

In this way the list of preferred networks can be modified according to the needs of the subscriber as derivable from location information.

Modifying the list of preferred networks may enhance the probability for a preferred network being chosen in the process of selecting a mobile communications network. The network provider's possibility to influence the selection of mobile networks for providing roaming services is enhanced, even if the SIM is used in handsets which only read part of the preferred network list, such as the first eight entries of the list. Thus considerably more roaming traffic may be retained within a particular group of co-operating network providers. The amount of roaming traffic in competitor's networks can be decreased. Also, supplementary services offered by the network provider may more reliably work in countries other than the area covered by the home network.

On the other hand, the method does not actively block any networks. Thus it is ensured that the subscriber is provided services even if the preferred network is not available for a particular area in the roaming country or at a particular time.

Preferably, the SIM is adapted to modify said list of preferred networks by an applet running on the subscriber identity module.

In this way a SIM applet running on the SIM of a mobile terminal in a mobile communications network may influence the selection procedure in the GSM framework, without the need of modifying the mobile terminals or any hardware parts of the SIM. The applet can for example be loaded and implemented onto the SIM Over-The-Air.

Preferably, said list is modified after it is determined that the subscriber identity module is being used in a country different from the country where it was last used.

The SIM only causes a modification of the contents of the preferred network list if it has been determined that a modification is necessary. A modification of the list in only needed if the subscriber has changed country since he last used the SIM. In this way it is ensured that the application consumes resources such as battery power efficiently and does not disturb other functionalities of the mobile terminal.

Preferably, the applet can be executed in a short time period such that the user may not even be aware that an application is running which influences the selection of a network for roaming. Thus the user acceptance for such an application is high.

According to another aspect of the present invention, there is provided a method of influencing the selection of a network for providing roaming services, said method comprising modifying, based on location information, the list of preferred networks stored on a subscriber identity module.

According to another aspect of the present invention, there is provided an application installed on a subscriber identity module for use in a mobile communications network, said application being adapted to influence, based on location information the process of selecting a network for providing roaming services.

Further aspects and advantages of the invention will be set out, by way of example only, from the following description and accompanying drawings, wherein:

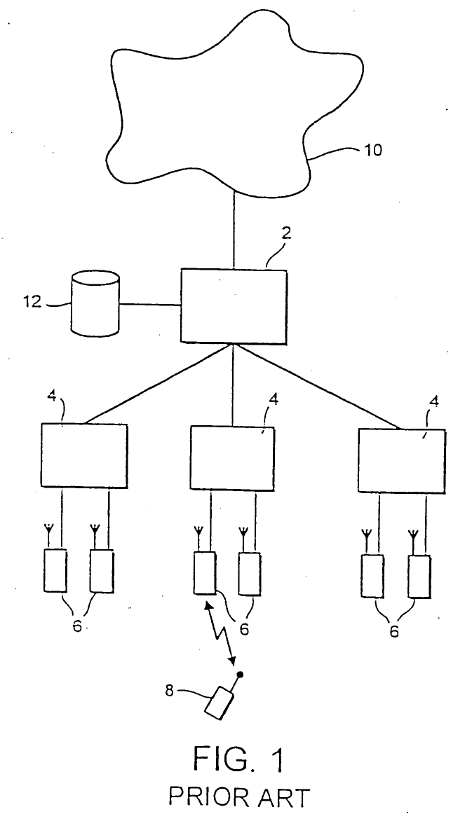

FIG. 1 is a general schematic outline of a GSM mobile communications network in which the present invention can be implemented;

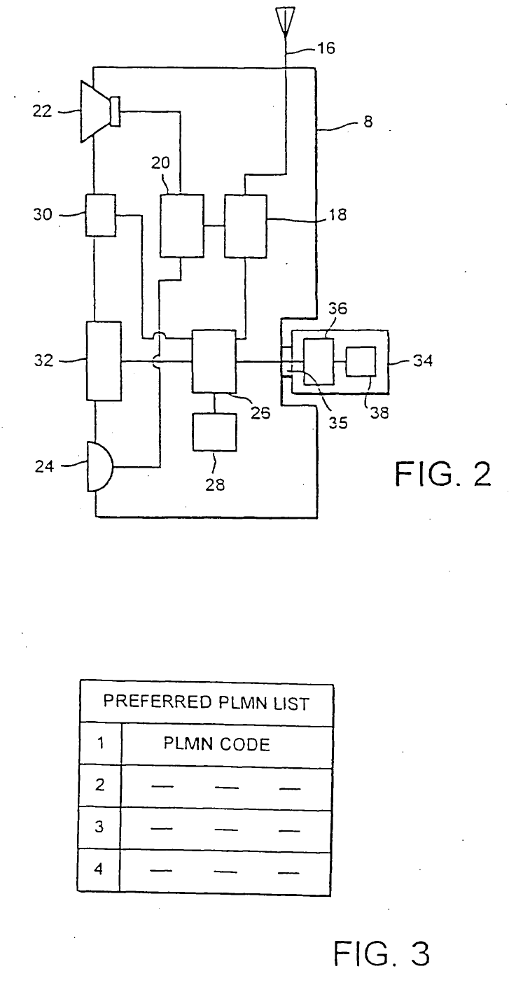

FIG. 2 is a block diagram of a mobile terminal for use in the network illustrated in FIG. 1;

FIG. 3 is a schematic illustration of a list in the memory of a mobile terminal;

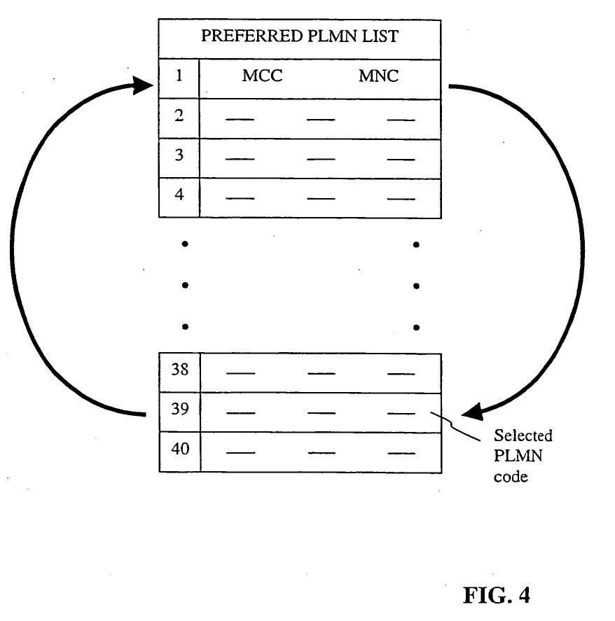

FIG. 4 is a schematic illustration of the procedure modifying the list of FIG. 3 according to an embodiment of the present invention; and

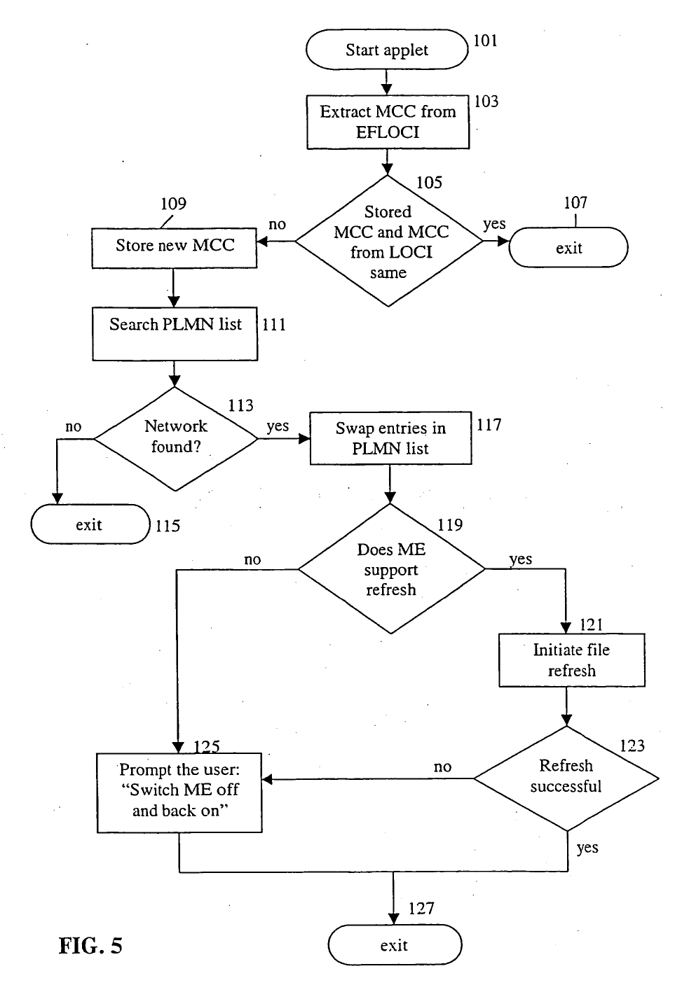

FIG. 5 is a flowchart diagram illustrating the procedure modifying the list of FIG. 3 to an embodiment of the present invention.

In FIG. 1 a schematic outline of a mobile telecommunications network according to the GSM standard is shown. A Mobile Switching Centre (MSC) is connected via communication links to a number of Base Station Controllers (BSCs) 4. The BSCs are dispersed geographically across areas served by the Mobile Switching Centre 2. Each BSC 4 controls one or more Base Transceiver Stations (BTSs) 6 located remote from, and connected by further communication links to, the BSC 4. Each BTS 6 transmits radio signals to, and receives signals from, mobile stations 8 which are in an area served by that BTS 6. The area is referred to as a “cell”. A GSM network is provided with a large number of such cells, which are ideally contiguous to provide continuous coverage over the whole network territory.

A MSC 2 is also connected via communications links to other mobile switching centres in the remainder of the mobile communications network 10, and to a public service telephone network (PSTN), which is not illustrated.

Referring to FIG. 2, a mobile station 8 comprises a transmit/receive aerial 16, a radio frequency transceiver 18, a speech coder/decoder 20 connected to a loudspeaker 22 and a microphone 24, a processor circuit 26 and its associated memory 28, an LCD display 30 and a manual input port (keypad) 32. The mobile station is connected to a removable SIM 34 via electrical contacts 35.

The SIM 34 connected to the mobile station has a SIM processor 36 and SIM memory 38.

The SIM 34 is used for the storage and retrieval of data items by the processor 26 of the mobile station 8. The command set, data file structure and data coding formal for data communicated via the interface between the mobile station processor 26 and the SIM processor 36 are all specified, in the GSM system, in GSM technical specification 11.11.

In the past, the SIM had a purely passive function and was used for storing data, mainly relating to the identification of a particular user, to authentication and security procedures.

Today, SIM cards have extended functionality and allow applications to be stored on the SIM card and interactions between the SIM card and the mobile equipment (ME). Such mechanisms can either be provided by the SIM application toolkit or special functionality. These implementations may be developed using a number of computer programming languages, such as C, Java™ or any other proprietary programming language.

Typical applications include downloading data to the SIM card. A user may for example store telephone numbers on the SIM rather than on the mobile equipment (ME). Other applications include the possibility of downloading “events”. In this case the application defines one or more events in which it has an interest. These events are subsequently monitored, and the event download mechanism is used to transfer details of the event to the SIM when it occurs. Events may for example information relating to a call via the call connect or disconnect events or updating of location information. More details can be found in GSM Technical Specification 11.14

Data records stored in the SIM memory 38 contain so-called elementary files, which include a header and a body part.

One example of such an elementary file stored in the SIM memory is the list of preferred networks as schematically illustrated in FIG. 3.

Another example is the elementary file location information (LOCI). This file includes the temporary mobile subscriber identity (TMSI), location area information (LAI) and location update status information.

According to one embodiment of the present invention, a SIM toolkit application is used to modify the list of preferred PLMN's. Referring to FIG. 4, this process is now described.

If the mobile terminal is moving from one cell to another, the location area information (LA) in the location information file (LOCI file) on the SIM is updated. This update triggers the roaming applet to start in step 101.

In order to achieve this the applet registers its interest in the event any elementary file LOCI is updated. The SIM will then trigger the applet to be executed and to notify the applet if the event occurs, i.e. if any elementary file is updated. In this case the applet first checks which file has been updated. If the LOCI file has been updated, the applet continues with step 103. If, on the other hand, the applet determined that a file other than the LOCI file has been updated, it ends.

In step 103, the applet extracts the mobile country code (MCC) from the LAI field of the LOCI file. The applet also stores the code of the lastly visited country, as will be described below. The MCC value as extracted from the LOCI file is then compared with the MCC value of the last country visited before the location update as stored in the applet. In step 105, the applet determines whether the present MCC is the same as the MCC stored in the applet.

If both country codes are the same, the applet ends in step 107. If, on the other hand, the MCC has changed, the applet stores the present mobile country code in step 109 and continues with step 111. The stored MCC value is now available for the applet and can be used for comparison with a MCC determined from the LOCI file at the next instance the applet is started.

In step 111, the applet searches the whole PLMN list stored on the SIM in order to find a suitable network for the country in which the subscriber is currently staying.

The PLMNs in the preferred PLMN file are listed with MCC followed by the Mobile Network Code (MNC). By comparing the present MCC as derived from the LOCI file to the MCCs as determined from the PLMN codes listed in the PLMN file, the applet is able to identify preferred networks for the country in which the subscriber is currently roaming.

If no suitable network for the present country can be found in step 113, the applet ends in step 115.

If a preferred network for the present country is found, in step 117 the applet swaps the code for the selected network and the code for the network which is placed on the top of the preferred network list.

This is done by reading the network code of the first entry of the PLMN list and subsequently writing this code into the list at the place where the selected network of the current country has been listed before. The code for the selected network of the current country is then written into the first place of the preferred PLMN list. This procedure of swapping the entries of the preferred PLMN list is illustrated in FIG. 4.

In this way the selected network for the current country gets the highest priority to be selected when the PLMN list is next read by the mobile terminal in order to select a mobile communications network. In this way the probability that a suitable network from the list of preferred PLMN is selected can be considerably enhanced, even for mobile terminals which only consider the first eight entries of the PLMN list.

In step 119, the applet determines whether the mobile terminal supports a file refresh functionality.

If the mobile terminal does, the applet initiates the “refresh” function for the PLMN file in step 121. The “refresh” option causes the mobile terminal to read the PLMN list as updated by the applet and thus to find the preferred network for the current country on the preferred network list. The mobile terminal will now find the suitable network when reading and acting on the PLMN list, even if the mobile terminal only reads a part of the PLMN list with the highest priority network, as the selected network is now listed on the top of the preferred PLMN list.

The handset will successfully select the network for the current country from the preferred PLMN list and offer the subscriber the usual services via the selected preferred network.

In step 123, the applet checks whether the file refresh function was successfully carried out by the mobile terminal. If this was the case, the applet ends in step 127.

If it was determined in step 123 that the refresh command was not carried out successfully, the applet prompts the user in step 125 to switch off the mobile terminal and subsequently to switch it on again in order to get the terminal to read and consider the preferred PLMN list as updated by the applet in step 117.

The applet also continues with step 125 by prompting the user if the mobile terminal determines in step 119 that the terminal does not support the file refresh function.

By causing the applet to change the preferred PLMN file after the applet has determined that the subscriber is roaming in a country different to the home country, the mobile terminal will automatically select a suitable preferred network for this particular country. The subscriber is usually not aware of the action of the applet and he may not even be aware that the mobile terminal changes the selection of a network, as the steps of executing the applet and the subsequent selection of the preferred network are usually carried out in a time period in the order of a second.

Whilst in the above described embodiment the execution of the applet is triggered by a change in the LOCI file, it is appreciated that alternatively other methods may be used to trigger execution of the applet.

The applet may for example be initiated periodically after predetermined time periods. In this case, the applet checks in a first step the LOCI file and extracts the MCC code of the LAI. If the applet determines that the location information has been updated and the MCC code in the LOCI file has been changed since the applet has performed the last check, it then initiates the search for a suitable network for the present country as described above.

Other modes of operation include the triggering of the applet on any other of the standard SIM Toolkit events as defined in Technical GSM Specification 03.19. These events include, for example, menu selection, SMS arrival or call control.

Whilst in the above described embodiment the applet swaps the first entry of the preferred PLMN list with the selected PLMN code for the present country, it is appreciated that alternatively the applet may rearrange the entries in the preferred network list in other ways.

The applet may for example set the selected network code of the present country on the first place of the list and shift all other entries above the original position of the selected network code one place further down the priority list.

However, it is important that the applet operates with as little impact on the user as possible, i.e. that the execution of the applet is fast enough such that the user does not have to wait before services from his mobile terminal are available. One possible solution is therefore that the applet writes the code of the selected entry to the first place of the list and subsequently shift the codes of the networks which have been the first seven entries of the PLMN list on place further down the priority list and writes the entry which has been on the eights place on the list to the place where the selected network have been before.

Other variations include the possibility that the applet may store the codes of the countries the subscriber has visited in the past or is visiting regularly and write those codes on top of the preferred PLMN list.

Whilst in the above described embodiment country codes stored in the LOCI file are used to determine that the subscriber is roaming in another country, it is appreciated that the location information which is required to select a suitable network for providing services in the country the subscriber is currently roaming can alternatively be provided to the applet in other ways.

Whilst in the above described embodiment the applet carrying out the modification of the preferred PLMN list is described to be a SIM Toolkit application, it is appreciated that alternatively application running on other platform, as for example JAVA applications running on a JAVA SIM may be used.

It is to be understood that the embodiments described above are preferred embodiments only. Namely, various features may be omitted, modified or substituted by equivalents, without departing from the scope of the present invention, which is defined in the accompanying claims.

1. A subscriber identity module for use in mobile communications networks, said subscriber identity module storing a list of preferred mobile communications networks, other than the home mobile network, to be selected for providing services, and
said subscriber identity module being adapted to modify said list of preferred networks based on location information.

2. A subscriber identity module according to claim 1, wherein said list is modified by an applet running on the subscriber identity module.

3. A subscriber identity module according to claim 1, wherein said location information is obtained from the elementary file location information stored on the subscriber identity module.

4. A subscriber identity module according to claim 1, further adapted to initiate action which may lead to the modification of said list of preferred networks in response to the location information elementary file being updated.

5. A subscriber identity module according to claim 1, wherein said location information includes a country code.

6. A subscriber identity module according to claim 1, further adapted to determine the country in which the subscriber identity module is being used.

7. A subscriber identity module according to claim 1, further adapted to modify said list after it is determined that the subscriber identity module is being used in a country different from the country where it was last used.

8. A subscriber identity module according to claim 1, further adapted to select a network from said list which provides services in the country in which the subscriber identity module is currently being used.

9. A subscriber identity module according to claim 8, further adapted to increase the priority of the selected network in the list of preferred networks.

10. A subscriber identity module according to claim 8, further adapted to swap the code of the selected network with the code at the first position of the preferred network list.

11. A subscriber identity module according to claim 1, further adapted to cause the mobile terminal connected to the subscriber identity module to use the modified list of preferred networks.

12. A subscriber identity module according to claim 1, further adapted to initiate a refresh command of the file containing the preferred network list.

13. A subscriber identity module according to claim 1, further adapted to prompt the user to cause the mobile terminal connected to the subscriber identity module to use the modified list of preferred networks.

14. A subscriber identity module according to claim 1, further adapted to prompt the user to switch the mobile terminal off and on to cause the mobile terminal connected to the subscriber identity module to use the modified list of preferred networks.

15. A method of influencing the selection of a network for providing roaming services, said method comprising modifying, based on location information, the list of preferred networks stored on a subscriber identity module.

16. A method according to claim 15, wherein said list of preferred networks is modified individually for each subscriber identity module.

17. A method according to claim 15, wherein said location information is obtained from Elementary file location information stored on the subscriber identity module.

18. A method according to claim 15, further comprising initiating action, which may lead to the modification of said list of preferred networks, in response to an update of elementary file location information stored on the subscriber identity module.

19. A method according to claim 15, wherein said location information includes a country code.

20. A method according to claim 15, said method further comprising determining the country in which the subscriber identity module is being used.

21. A method according to claim 15, wherein said list is modified after it is determined that the subscriber identity module is being used in a country different from the country where it was last used.

22. A method according to claim 15, wherein a network is selected from the list of preferred networks, and wherein the selected network provides services in the country in which the subscriber is roaming.

23. A method according to claim 22, wherein the priority of the selected network in the list of preferred networks is increased, such that the mobile terminal connected to the subscriber identity module reads the code of the selected network when the mobile terminal is selecting a network for providing roaming services.

24. A method according to claim 22, wherein the code of the selected network is swapped with the code at the first position of the preferred network list.

25. A method according to claim 15, wherein the mobile terminal connected to the subscriber identity module uses the modified list of preferred networks.

26. A method according to claim 15, wherein a refresh command of the file containing the preferred network list is initiated after the file has been updated.

27. A method according to claim 15, further comprising prompting the user to cause the mobile terminal to read the file containing the preferred network list after the file has been updated.

28. A method according to claim 15, further comprising prompting the user to switch the mobile terminal off and on to cause the mobile terminal connected with the subscriber identity module to use the modified list of preferred networks after the file has been updated.

29. An application for installation on a subscriber identity module for use in a mobile communications network, said application being adapted to perform a method of influencing the selection of a network for providing roaming services, said method comprising modifying, based on location information, the list of preferred networks stored on a subscriber identity module.

30. An application for installation on a subscriber identity module for use in a mobile communications network, said application being adapted to influence, based on location information, the process of selecting a network for providing roaming services.

31. A signal including an application for installation on a subscriber identity module for use in a mobile communications network, said application being adapted to perform a method of influencing the selection of a network for providing roaming services, said method comprising modifying, based on location information, the list of preferred networks stored on a subscriber identity module.

32. A mobile terminal connected to a subscriber identity module for use in mobile communications networks,
said subscriber identity module storing a list of preferred mobile communications networks, other than the home mobile network, to be selected for providing services, and
said subscriber identity module being adapted to modify said list of preferred networks based on location information.

33. A mobile terminal according to claim 32, wherein the priority of the selected network in the list of preferred networks is increased, such that the mobile terminal connected to the subscriber identity module reads the code of the selected network when the mobile terminal is selecting a network for providing roaming services.

34. (canceled)

35. A signal including an application for installation on a subscriber identity module for use in a mobile communications network, said application being adapted to influence, based on location information, the process of selecting a network for providing roaming services.
